(19) United States
(12) Patent Application Publication
(10) Pub. No.: US 2007/0143290 A1
(43) Pub. Date: Jun. 21, 2007

(54) Priority Determination Apparatus, Service Processing Allocation Apparatus, Control Method and Program

(75) Inventors: Yohhei Fujimoto, Yokohama-shi, Kanagawa-ken (JP); Daitoku Saito, Yokohama-shi, Kanagawa-ken (JP); Tohru Shiga, Yokohama-shi, Kanagawa-ken (JP); Yasuhiro Suzuki, Machida-shi, Tokyo (JP)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/306,575

(22) Filed: Jan. 3, 2006

(30) Foreign Application Priority Data
Jan. 4, 2005 (JP) 2005000201

(51) Int. Cl. G06F 17/30

(52) U.S. Cl. 707/9

(57) ABSTRACT

A service priority is changed to allow an application server more flexibly to cope with diversified sales promotion strategies in electronic commerce. The priority of a service is determined by a service request history recording section for each user, a section for identifying the user who requested a service in response to receiving a request for the service made to the application server, and a section for determining a priority to be used in processing the service requested by the user.

The present invention relates to priority determination and service processing allocation. Particularly, the present invention relates to a control method and a program for determining priority of a service to be processed by an application server.

### BACKGROUND ART

In recent years, many information processing systems for providing services on the Internet have been implemented by a plurality of application servers to improve processing capability and availability. It has been suggested to select an application server for processing a request if the request is made to the application server in the hyper text transfer protocol (HTTP).

According to the above technology, a user who requests a service is associated with an application server. When processing capability of the application server becomes insufficient, a new application server is additionally allocated to the user. This enables load balancing for the application servers while maintaining user-friendliness. Furthermore, it has been suggested to controll quality of images transmitted to client machines according to a predetermined service request level for each client machine.

However, the above technology does not change the allocation unless the load on the application server changes. Therefore, a frequent user of services, cannot be treated more favorably by speeding up his/her service processing. Similarly, a service request level for each client machine is predefined so that it is impossible to dynamically change the service request level depending on the use status.

### SUMMARY OF THE INVENTION

Therefore, it is an object of the present invention to provide a priority determination apparatus, a service request allocation apparatus, a control method, and a program capable of resolving the above problems. This object is achieved by a combination of features described in the independent claims herein. The dependent claims define further advantageous embodiments of the present invention.

In order to solve the above problems, the present invention provides a priority determination apparatus for determining a priority of a service to be processed by an application server, comprising a service request history recording section for recording a service request history of a service requested to the application server in association with each user who requested the service, a user identification section for identifying a user who requested the service in response to receiving the service request made to the application server, and a priority determination section for determining a priority to be used in processing the service requested by the user on the basis of the service request history associated with the user, regarding the user identified by the user identification section; a service processing allocation apparatus including the priority determination apparatus; control methods for the priority determination apparatus and the service processing allocation apparatus; and programs for controlling the priority determination apparatus and the service processing allocation apparatus.

Note that the above outline of the present invention does not enumerate all of the characteristics necessary for the present invention. A subcombination of groups of the characteristics may also represent the present invention.

According to the present invention, a priority of a service to be processed by an application server can be changed more flexibly so that it is possible to cope with diversified sales promotion strategies in electronic commerce.

### BRIEF DESCRIPTION OF THE DRAWINGS

FIG. 1 shows the overall configuration of a service processing system according to the present invention;

FIG. 2 shows functions of a service processing allocation apparatus in function blocks;

FIG. 3 shows functions of a priority determination apparatus in function blocks;

FIGS. 4A and 4B show an outline of a request queue group;

FIG. 5 shows an example of a data structure of a service request history recording section;

FIG. 6 shows a process flow of service processing carried out by a service processing system;

FIG. 7 shows details of the process of FIG. 6;

FIG. 8 shows an example of a data structure of a priority policy recording section;

FIG. 9 shows an example of a process to determine user importance;

FIG. 10 shows functions of a service processing allocation apparatus according to a modified embodiment in function blocks; and

FIG. 11 shows an example of hardware configuration of an information processing apparatus which functions as the service processing allocation apparatus according to the embodiment or the modified embodiment.

### DETAILED DESCRIPTION OF THE INVENTION

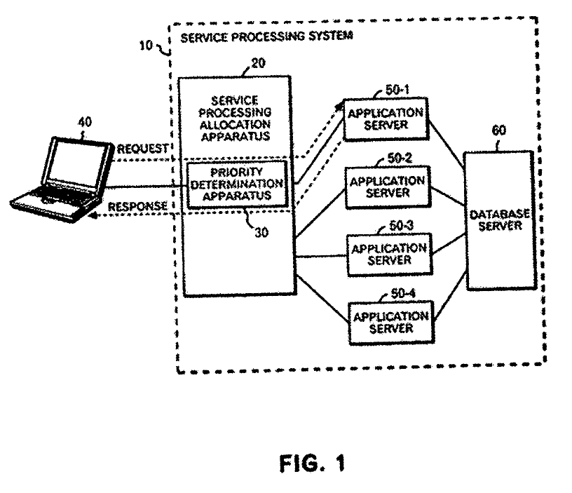

FIG. 1 shows the overall configuration of a service processing system 10 according to one embodiment. The service processing system 10 includes a service processing allocation apparatus 20, application servers 50-1 to 50-4, and a database server 60. The service processing allocation apparatus 20 receives a request for a service transmitted from a user through operation of a user terminal 40. Once the service request is received, a priority determination apparatus 30 included in the service processing allocation apparatus 20 determines the priority of the service to be processed by one of the application servers 50-1 to 50-4. Thereafter, the service processing allocation apparatus 20 allocates the requested service to one of the application servers 50-1 to 50-4. Upon receipt of the service request, each of the application servers 50-1 to 50-4 communicates with the database server 60, and if required, processes the service, and responds to the user terminal 40 with a processing result.

At this time, the priority determination apparatus 30 determines a priority of processing a service requested by the user based upon the history of service requests made by the user in the past. Accordingly, a priority of service processing can be changed more flexibly so that it is possible to cope with diversified sales promotion strategies in electronic commerce.

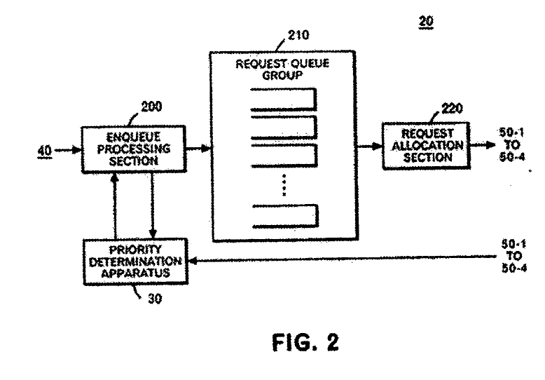

FIG. 2 shows functions of the service processing allocation apparatus 20 in functional blocks. The service processing allocation apparatus 20 has an enqueue processing section 200, a request queue group 210, and a request allocation section 220 in addition to the priority determination apparatus 30. The request queue group 210 includes a plurality of request queues for storing service requests made to the application servers 50-1 to 50-4. The enqueue processing section 200 acquires a service request from the user terminal 40. The priority determination apparatus 30 determines a priority of service processing with regard to the acquired service request based upon the service request history of the user who requested the service. The priority determination apparatus 30 may also use information obtained from the application servers 50-1 to 50-4 to determine the priority of service processing.

The enqueue processing section 200 enqueues the service request from the user into a request queue corresponding to the priority determined by the priority determination apparatus 30. The request allocation section 220 acquires a request from one of the request queues on the basis of the priority corresponding to the request queue and allocates the request to one of the application servers 50-1 to 50-4. Note that, in the description below, the application servers 50-1 to 50-4 are collectively referred to as an application server unless individual descriptions are needed for the application servers 50-1 to 50-4.

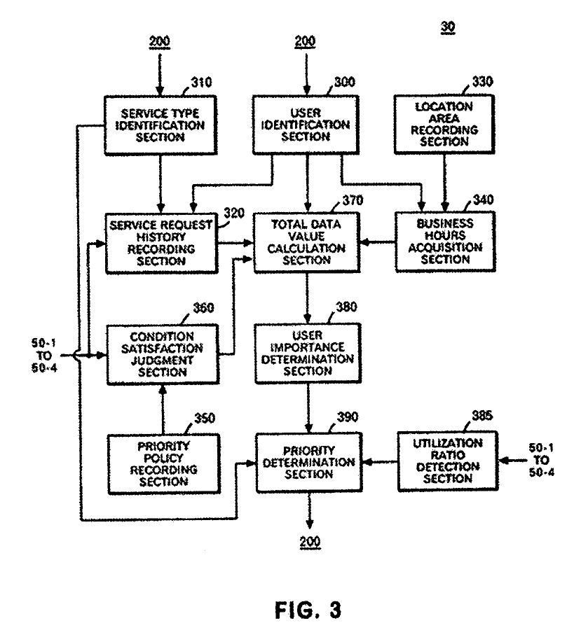

FIG. 3 illustrates the priority determination apparatus 30 in function blocks. The priority determination apparatus 30 includes a user identification section 300, a service type identification section 310, a service request history recording section 320, a location area recording section 330, a business hours acquisition section 340, a priority policy recording section 350, a condition satisfaction judgment section 360, a total data value calculation section 370, a user importance determination section 380, a utilization ratio detection section 385, and a priority determination section 390. In response to receiving a service request made to the application server, the user identification section 300 identifies the user who requested the service, and the service type identification section 310 identifies the type of service. A type of service means the type of application program of the requester who requests a service. Alternatively, a type of a service may represent a protocol such as HTTP, FTP or TELNET used for service requests or responses to the requests.

The service request history recording section 320 records a service request history of services requested to the application server in association with each user who requested the service. For example, every time a service request is received, the service request history recording section 320 receives a service request history included in the request and records the service request history received. Alternatively, the service request history recording section 320 may record a service request history of each user in advance. A service request history may include data values such as the number of service requests made by a user, a response time from requesting a service by a user to returning a processing result, the volume of communication conducted by the application server through a network in response to a service request made by a user, or the number of transactions that the application server instructed the database server 60 in response to a service request made by a user.

The location area recording section 330 records a location area of each user in advance. The business hours acquisition section 340 acquires a location area of each user from the location area recording section 330 and acquires business hours predetermined for each location area. Each location area is, for example, associated with a standard time of the area or business hours based upon the culture and customs in the area, and the business hours acquisition section 340 may acquire business hours of the area based upon a country or an administrative district where the user is located.

The priority policy recording section 350 records at least one priority policy for giving priority to a certain service requested by a certain user. For example, the priority policy recording section 350 records a plurality of conditions for each priority policy which should be met to set that priority policy to the priority determination apparatus 30. The condition satisfaction judgment section 360 judges whether each of the conditions corresponding to a priority policy stored in the priority policy recording section 350 is satisfied.

The total data value calculation unit 370 acquires a service request history corresponding to a user who requested a service, from the service request history recording section 320. Thereafter, the total data value calculation section 370 calculates a total value by totalizing a sum of a value obtained by multiplying each data value by a positive weight and a value obtained by multiplying each data value of the service request history by a negative weight, for all the data values. Specifically, the priority policy recording section 350 stores, for each priority policy, weights by which each of the above data values is multiplied in the state that the priority policy is set in the priority determination apparatus 30. The total data value calculation section 370 may calculate the above total value by using a weight calculated by multiplying each of the weights corresponding to a certain priority policy by a ratio of satisfied conditions in the plurality of conditions corresponding to the priority policy.

The user importance determination section 380 determines the importance of each user based upon the service request history of the user. Specifically, the user importance determination section 380 determines the importance of a user identified by the user identification section 300 based upon the total value calculated by the total data value calculation section 370 for the user. For example, the user importance determination section 380 rearranges total values calculated by the total data value calculation section 370 for the respective users in ascending or descending order. Thereafter, the user importance determination section 380 determines users in the largest 10% of the total values as users in a gold class with the highest level of importance. Users in the smallest 10% of the total values are determined as those in a bronze class with a relatively low level of importance, and the rests of the users are determined as users in a silver class with an intermediate level of importance.

The utilization ratio detection section 385 detects a utilization ratio of processing capability in the application server. For example, the utilization ratio detection section 385 may detect a use ratio of a central processing unit in the application server or occupancy of a main memory as the utilization ratio. The priority determination section 390 then determines a priority, which varies depending upon the user importance or service type, under the condition that the utilization ratio detected by the utilization ratio detection section 385 is equal to or greater than a predetermined reference value. On the other hand, if the utilization ratio is smaller than the reference value, the priority determination section 390 determines the same priority irrespective of the user importance or service type.

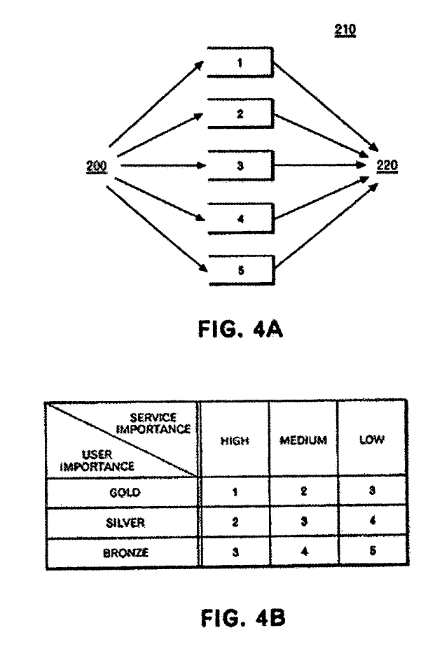

FIGS. 4 shows an outline of the request queue group 210. FIG. 4A is a schematic diagram showing a structure of the request queue group 210. As shown in FIG. 4A, the request queue group 210 includes a plurality of request queues associated with the priorities 1 to 5, respectively, which store service requests made to the application server. The enqueue processing section 200 enqueues a service request made by a user into a request queue corresponding to a priority determined by the priority determination section 390.

The request allocation section 220 acquires requests from the request queues based upon priorities corresponding to the request queues and allocates the requests to the appropriate application servers 50-1 to 50-4. For example, the request allocation section 220 acquires requests only from the request queue with the priority 1 but not from the request queue with the priority 2 until the request queue with the priority 1 becomes empty. The request allocation section 220 starts acquiring requests from the request queue with the priority 2 only after the request queue with the priority 1 becomes empty. Alternatively, the request allocation section 220 may acquire requests from the request queue with the priority 2 before the request queue with the priority 1 becomes empty. In this case, for example, the request allocation section 220 may acquires requests from the request queue with the priority 1 more frequently than acquiring requests from the request queue with the priority 2.

FIG. 4B shows a specific example of priorities determined by the priority determination section 390. The priority determination section 390 determines each priority based upon a combination of a user importance level and a service importance level predetermined in accordance with a service type. Specifically, the priority determination section 390 determines a higher priority from among a plurality of priorities fewer than a number obtained by multiplying the number of service importance levels by the number of user importance levels if the service is of the same type and the user importance is higher, or if the user importance is of the same level and the service importance is higher. For example, if a user importance level is the silver class and a service importance level is middle, the priority is determined to be 3. In this case, the enqueue processing section 200 stores a request into the request queue corresponding to the priority 3.

As explained above, the request allocation section 220 allocates service processing by using the request queues fewer than the number made by multiplying the number of user importance levels by the number of service importance levels. Thus, in this example, the number of request queues increases in proportion to the number of importance levels rather than to the square of the number of importance levels. Ideally, the number of request queues required should be equal to a sum of the numbers of user and service importance levels minus one. This prevents the number of request queues from considerably increasing greater than the number of importance levels even if the number of importance levels becomes extremely large.

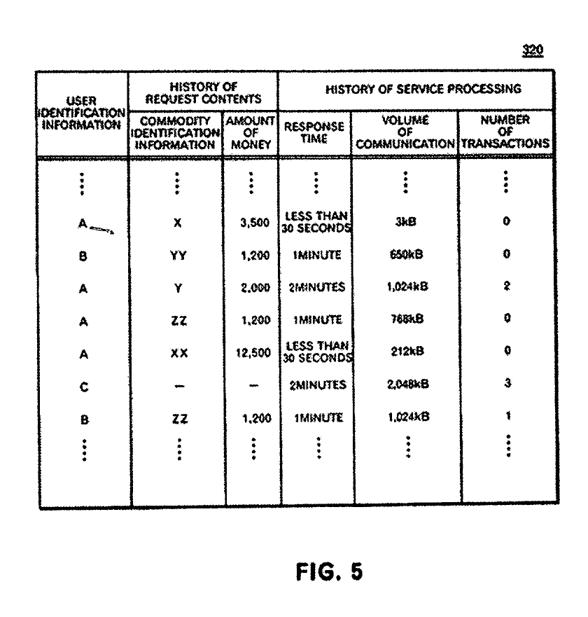

FIG. 5 shows an example of the data structure of the service request history recording section 320. The service request history recording section 320 records histories of service requests made to the application server in association with users who made the service requests. A service request history may include, for example, a history of service request contents and a history of service processing performed in response to the requests.

Taking a service request made on a web page for a commodity sales transaction, for example, a service request history may include identification information of a commodity for which a purchase request was made on the web page and information showing an amount of money paid to purchase the commodity. In this case, for example, if the total amount of money corresponding to a user identified by the user identification section 300 is higher, the user importance determination section 380 may determine a higher importance for that user in comparison with the case that the total amount of money is less. Also, the user importance determination section 380 may determine a higher importance for the user if the amount of money paid for one service associated with the user is higher, in comparison with the case that the amount of money is less. Thus, it is possible to determine the importance in accordance with specific economic or physical effects provided to a commodity trader by a requested service.

Alternatively, the user importance determination section 380 may determine a higher importance if commodities associated with a user identified by the user identification section include a predefined commodity, in comparison with a case that the predefined commodity is not included in the commodities associated with that user. Here, the predefined commodity may be a right to prioritize the user to have an access to the application server. In this case, the user can cause a desired service to be processed with priority by purchasing this right.

In addition, the service request history may include a response time from requesting a service to responding to the request, the volume of communication within the service processing system 10 generated due to the service request, and/or the number of transactions to the database server 60 as a result of the service request. If the importance is determined based upon these data values, it becomes possible to control loads, power consumption, or heat dissipation in the application server.

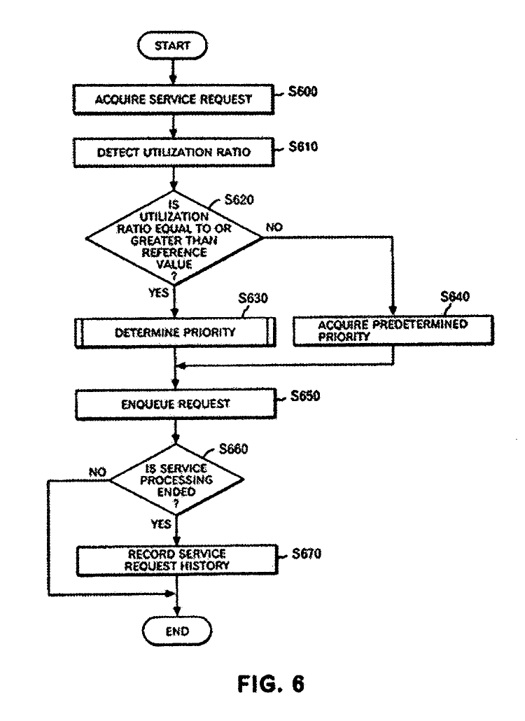

FIG. 6 shows a process flow for service processing by the service processing system 10. The enqueue processing section 200 acquires a service request from a user (S600). The utilization ratio detection section 385 then detects a utilization ratio of processing capability in the application server (S610). If the utilization ratio is equal to or greater than a reference value (S620:Yes), the priority determination apparatus 30 determines a priority, which is different for each user, based on the service request history of the user who requested the service (S630). On the other hand, if the utilization ratio is less than the reference value (S620: NO), the enqueue processing section 200 acquires a predetermined priority which is the same for the services requested by that user and other users (S640).

Thereafter, the enqueue processing section 200 enqueues the request in one of the request queues based on the priority. Once the processing of the service is ended (S660: YES), the application server adds the service request history of the ended service to the history of the past service requests (S670). For example, the application server may update the service request history included in the service request and returns it to the user terminal 40 as a response to the request. Alternatively, the service request history recording section 320 may acquire and record the result of the service processing from the application server.

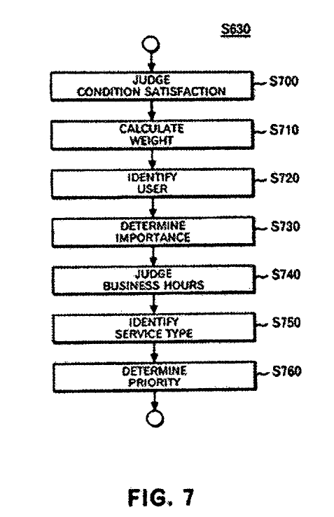

FIG. 7 shows the details of the processing in S630 shown in FIG. 6. The condition satisfaction judgment section 360 judges whether each of a plurality of conditions corresponding to a priority policy stored in the priority policy recording section 350 is satisfied (S700). Then, the total data value calculation section 370 calculates a weight by multiplying each weight corresponding to the priority policy by a ratio of satisfied conditions in the plurality of conditions corresponding to the priority policy (S710). A specific example of this processing is described below.

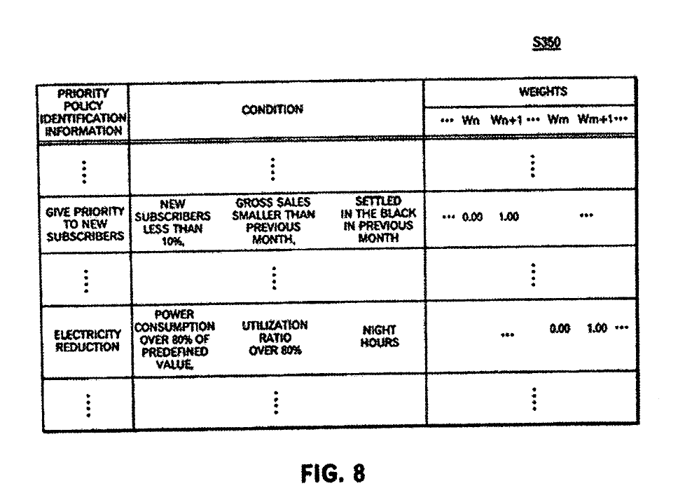

FIG. 8 shows an example of the data structure of the priority policy recording section 350. The priority policy recording section 350 stores, for each of at least one priority policy, a plurality of conditions to be satisfied in order to set that priority policy in the priority determination apparatus 30, and weights by which the respective data values mentioned above are muliplied in a state where that priority policy is set in the priority determination apparatus 30. For example, as for the priority policy “give priority to new subscribers”, the conditions “ratio of new subscribers is less than 10%”, “gross sales are less than previous month”, and “settled in the black in previous month” are stored in association with that priority policy. In addition, with regard to that priority policy, weights Wᵢ, in which Wₙ=0.00 and Wₙ₊₁=1.00, are stored in association with that priority policy.

The condition satisfaction judgment section 360 judges whether each of the conditions for that priority policy is satisfied. For example, if the conditions “ratio of new subscribers is less than 10%” and “gross sales are less than previous month” are satisfied, the ratio of satisfied conditions to all the conditions corresponding to that priority policy is 2/3. Therefore, the total data calculation section 370 calculates the weight Wₙ₊₁ as Wₙ₊₁=1.00×2/3=0.67.

Returning to FIG. 7, the user identification section 300 identifies a user who made a request for a service (S720). Then, the user importance determination section 380 determines the importance of the user based upon the service use history corresponding to the user (S730). The user identification section 300 identifies a user who made a service request to the application servers (S720). For example, a cookie for identifying the user may be preset in the web browser running in the operation environment of the user, and the user identification section 300 may acquire information preset as the cookie included in the service request to identify the user.

The user importance determination section 380 determines the importance of the user identified by the user identification section 300 (S730). Next, the business hours acquisition section 340 judges whether the present time belongs to the business hours of the user (S740). The service type identification section 310 identifies the type of the service requested by the user (S750). Then, the priority determination section 390 determines a priority based upon the importance levels of the user and the service, and the condition of whether the present time belongs to the business hours. Specifically, if the present time belongs to the business hours corresponding to the user, the priority determination section 390 may determine a higher priority than a case that the present time does not belong to the business hours. For example, the priority determination section 390 may determine a priority based upon a combination of the importance levels of the user and the service, and raise the priority by one level if the present time belongs to the business hours.

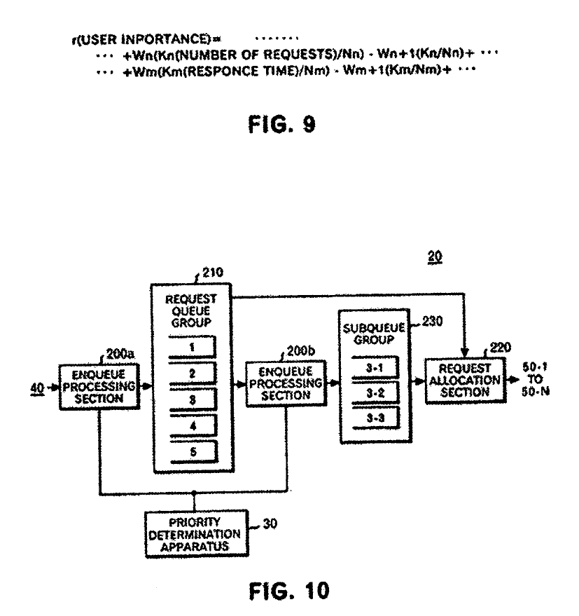

FIG. 9 shows an example of processing for determining the user importance. In S730 in FIG. 7, the user importance determination section 380 determines the importance of a user based upon the service request history of the user. In this case, FIG. 9 describes an example of processing for summing the data values contained in the service request history by the total data value calculation section 370. The total data value calculation section 370 calculates a sum of a value obtained by multiplying a data value Kₙ representing the number of service requests by a positive weight Wₙ and a value obtained by multiplying the data value Kₙ by a negative weight −Wₙ₊₁. Further, the total data value calculation section 370 calculates a sum of a value obtained by multiplying a data value Kₘ representing a response time from requesting a service to returning a processing result by a positive weight Wₘ and a value obtained by multiplying the data value Kₘ by a negative weight −Wₘ₊₁. Similarly, the total data value calculation section 370 calculates a sum of a value obtained by multiplying each of the remaining data values by a positive weight and a value obtained by multiplying the same by a negative weight. Finally, the total data value calculation section 370 calculates a total value r by totalizing these sums.

Next, the user importance determination section 380 arranges the total values r for the respective users in, for example, descending order. Then, if a total value r for a user identified by the user identification section 300 belongs to the top 10% of the arranged total values r for the respective users, the user importance determination section 380 determines the user as a gold class user who has higher importance than the others. Further, if the total value r for the user belongs to the bottom 10% of the arranged total values r for the respective users, the user importance determination section 380 determines the user as a bronze class user who has lower importance than the others. As for the other users, the user importance determination section 380 determines the other users as silver class users who have a medium level of importance.

As an example of the weights shown in FIG. 9, assuming that Wₙ is 1.00 and Wₙ₊₁ is 0.00, the user importance determination section 380 may determine a higher level of importance for a user identified by the user identification section 300 if there are more requests associated with the user, in comparison with the case where there are less requests associated with the user. In this case, it is possible to give priority to a regular user who continues requesting services. On the other hand, assuming that Wₙ is 0.00 and Wₙ₊₁ is 1.00, the user importance determination section 380 may determine a higher level of importance for a user identified by the user identification section 300 if there are less requests associated with the user, in comparison with the case where there are more requests associated with the user. In this case, it is possible to give priority to a new user who has made less service request.

Alternatively, the user importance determination section 380 may determine a higher importance under the condition that the number of requests associated with a user identified by the user identification section 300 is greater than a first predetermined number or is smaller than a second predetermined number that is smaller than the first predetermined number, in comparison with a case where the number of requests is between the first predetermined number and the second predetermined number. This makes it possible to give priority to both regular and new users.

According to the processing shown in the drawings, each data value contained in a service request history can be used as an element which either increases or decreases a level of importance. Therefore, it is possible to enhance flexibility of processing for determining a level of importance and to apply the above to various methods of importance determination.

FIG. 10 shows functions of the service processing allocation apparatus 20 in the function blocks according to a modified embodiment of the present invention. The service processing allocation apparatus 20 of the modified embodiment includes two enqueue processing sections 200a and 200b instead of the enqueue processing section 200 of the service processing apparatus 20 shown in FIG. 2. Further, the service. processing allocation apparatus 20 has a subqueue group 230 in addition to the functions of the service processing allocation apparatus 20 shown in FIG. 2. The request queue group 210 includes less request queues than a number obtained by multiplying the number of service importance levels by the number of user importance levels, for example, five request queues 1 to 5. The subqueue group 230 includes a plurality of subqueues which store requests obtained from at least one of the request queues.

The enqueue processing section 200a enqueues a service request from a user into a request queue corresponding to a priority determined by the priority determination apparatus 30. For example, as shown in FIGS. 4A and 4B, the priority determination apparatus 30 determines a priority of a service request based upon a combination of the three-level user importance and the three-level service importance. The enqueue processing section 200a enqueues the request into a request queue corresponding to the determined priority.

In the enqueuing operation, as seen from FIG. 4B, the request queue 3 may store a plurality of requests having different user or service importance levels. In the configuration shown in FIG. 2, these requests are processed by the application server with the same priority. However, since they have different user or service importance levels while having the same priority, it may be required to define some processing order for these requests.

Therefore, in this modified embodiment, the enqueue processing section 200b enqueues each of a plurality of requests acquired from the request queue 3 into one of the subqueues determined in accordance with the user importance or the service importance under the condition that the levels of the user importance or the service importance differ from each other.

Specifically, the enqueue processing section 200b receives an instruction indicating which should be based, the user importance or the service importance, from the priority determination apparatus 30. If the enqueue processing section 200b receives an instruction indicating the user importance, the enqueue processing section 200b enqueues each of the plurality of requests obtained from the request queue 3 into one of the subqueues 3-1 to 3-3 based upon the importance of the user corresponding to that request. On the other hand, if the enqueue processing section 200b receives an instruction indicating the service importance, the enqueue processing section 200b enqueues each of the plurality of requests obtained from the request queue 3 into one of subqueues 3-1 to 3-3 based upon the importance of the service corresponding to that request.

The request allocation section 200 obtains a request from one of request queues 1, 2, 4 and 5, and allocates it to the application server, and further obtains a request from each of the subqueues 3-1 to 3-3 based upon the priority predetermined for each subqueue and allocates it to the application server.

In this modified embodiment, it is also possible to prevent the number of the request queues from significantly increasing in comparison with the number of importance levels, and further possible to control the priority for service processing more finely by introducing the subqueues.

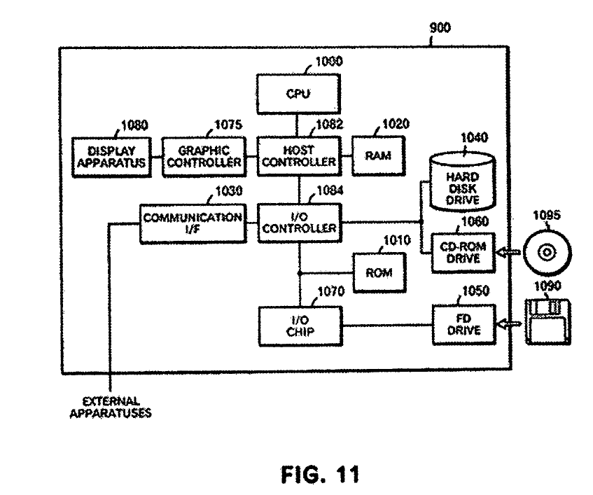

FIG. 11 shows an example of hardware configuration of an information processing apparatus 900 which functions as the service processing allocation apparatus 20 according to the embodiment or the modified embodiment. The information processing apparatus 900 is provided with a CPU-related section having a CPU 1000, a RAM 1020, and a graphic controller 1075 connected with one another by a host controller 1082, an input/output section having a communication interface 1030, a hard disk drive 1040, and a CD-ROM drive 1060 all connected with the host controller 1082 through an input/output controller 1084, and a legacy input/output section having a ROM 1010, a flexible disk drive 1050 and an input/output chip 1070 connected with the input/output controller 1084.

The host controller 1082 connects the RAM 1020 with the CPU 1000 and the graphic controller 1075 which access the RAM 1020 with a high transfer rate. The CPU 1000 operates based upon programs stored in the ROM 1010 and the RAM 1020, and controls each section. The graphic controller 1075 obtains image data created by the CPU 1000 or any other element on a frame buffer provided within the RAM 1020 and displays the image data on a display apparatus 1080. Alternatively, the graphic controller 1075 may internally include the frame buffer for storing image data created by the CPU 1000 or any other element.

The input/output controller 1084 connects the host controller 1082 with the communication interface 1030, the hard disk drive 1040 and the CD-ROM drive 1060 which are relatively high speed input/output devices. The communication interface 1030 communicates with external apparatuses through a network. The hard disk drive 1040 stores programs and data used by the information processing apparatus 900. The CD-ROM drive 1060 reads a program or data from the CD-ROM 1095 and provides the program or data to the RAM 1020.

Further, the input/output controller 1084 is connected with the ROM 1010, and relatively slow speed input/output devices such as the flexible disk drive 1050 and the input/output chip 1070. The ROM 1010 stores a boot program executed by the CPU 1000 when booting up the information processing apparatus 900, and other programs depending on the hardware of the information processing apparatus 900. The flexible disk drive 1050 reads a program or data from a flexible disk 1090 and provides the program or data to the RAM 1020. The input/output chip 1070 is connected with the flexible disk, 1090 and other input/output devices through, for example, a parallel port, a serial port, a keyboard port, a mouse port, etc.

A program to be provided to the information processing apparatus 900 is stored in a recording medium such as the flexible disk 1090, the CD-ROM 1095, an IC card, etc., and provided by a user. The program is read-from the recording media through the input/output chip 1070 and/or the input/output controller 1084, installed into the information processing apparatus 900, and then executed. Since the operation to be performed in the information processing apparatus 900 according to the program is the same as that of the service processing allocation apparatus 20 described with reference to FIGS. 1 to 10, its description will be omitted.

The program described above may be stored in an external recording medium. The recording medium may be an optical recording medium such as a DVD or PD, a magneto-optical recording medium such as an MD, a tape medium, a semiconductor memory such as an IC card, or any other medium, in addition to the flexible disk 1090 or the CD-ROM 1095. Further, a storage device such as a hard disk, a RAM or the like provided in a server system connected through a dedicated communication network or the Internet may be used as the recording medium, and the program may be provided to the information processing apparatus 900 through the network.

While the present invention has been described with reference to the embodiment, the technical scope of the present invention is not limited to the embodiment. It is obvious for a person skilled in the art to add various changes or improvements to the embodiment. It is also obvious from the description of claims that any such changes or improvements added are also included in the technical scope of the present invention.

What is claimed is:

1. A priority determination apparatus for determining a priority of a service to be processed by an application server, comprising:
a service request history recording section for recording a service request history of services requested to the application server in association with each user who requested the services;
a user identification section for identifying a user who requested a service in response to receiving a request for the service made to the application server; and
a priority determination section for determining a priority to be used in processing the service requested by the user on the basis of the service request history associated with the user, regarding the user identified by the user identification section.

2. The priority determination apparatus according to claim 1, further comprising a service type identification section for identifying a type of a service in response to receiving a request for the service made to the application server,
wherein the priority determination section determines the priority of the requested service on the basis of importance of the service, with the importance being predetermined depending on the type identified by the service type identification section.

3. The priority determination apparatus according to claim 2, further comprising:
a user importance determination section for determining importance of each user on the basis of the service request history corresponding to the user; and
wherein the priority determination section selects a higher priority from among a plurality of priorities fewer than a number obtained by multiplying the number of service importance levels by the number of user importance levels if the service is of the same type and the user importance is higher, or if the user importance is of the same level and the service importance is higher.

4. The priority determination apparatus according to claim 1:
wherein the service request history recording section records the number of service requests made by a user as the service request history in association with that user;
the priority determination apparatus further comprises a user importance determination section for determining a higher importance if there are more requests associated with the user identified by the user identification section, in comparison with the case where there are less requests; and
the priority determination section makes the priority higher if the importance determined by the user importance determination section is higher.

5. The priority determination apparatus according to claim 1:
wherein the service request history recording section records the number of service requests made by a user as the service request history in association with that user,
the priority determination apparatus further comprises a user importance determination section for determining a higher importance if there are more requests associated with the user identified by the user identification section, and
the priority determination section makes the priority higher if the importance determined by the user importance determination section is higher.

6. The priority determination apparatus according to claim 1:
wherein the service request history recording section records the number of service requests made by a user as the service request history in association with that user;
the priority determination apparatus further comprises a user importance determination section for determining a higher importance under the condition that the number of requests associated with the user identified by the user identification section is greater than a first predetermined number or is smaller than a second predetermined number that is smaller than the first predetermined number, in comparison with a case where the number of requests is between the first predetermined number and the second predetermined number, and
the priority determination section makes the priority higher if the importance determined by the user importance determination section is higher.

7. The priority determination apparatus according to claim 1:
wherein the service request history recording section records an amount of money paid by a user for a commodity through the service requested by that user in association with that user;
the priority determination apparatus further comprises a user importance determination section for determining a higher importance if the total amount of money associated with the user identified by the user identification section is larger, in comparison with the case that the total amount of money is less; and
the priority determination section makes the priority higher if the importance determined by the user importance determination section is higher.

8. The priority determination apparatus according to claim 1:
wherein the service request history recording section records an amount of money paid by a user for a commodity through the service requested by that user in association with that user;
the priority determination apparatus further comprises a user importance determination section for determining a higher importance if the amount of money paid for one service associated with the user is higher, in comparison with the case that the amount of money is less; and
the priority determination section makes the priority higher if the importance determined by the user importance determination section is higher.

9. The priority determination apparatus according to claim 1, further comprising a utilization ratio detection section for detecting a utilization ratio of processing capability in the application server:
wherein the priority determination section determines a priority, which is different for each user, based upon the service request history associated with that user under further condition where the utilization ratio detected by the utilization ratio detecting section is equal to or greater than a predetermined reference value, and equalizes the priority for the services requested by that user and other users under the condition that the utilization ratio is less than the predetermined reference value.

10. The priority determination apparatus according to claim 1:
wherein the service request history recording section records a commodity purchased by a user through a service requested by that user in association with that user,
the priority determination apparatus further comprises a user importance determination section for determining a higher importance if commodities associated with the user identified by the user identification section include a predefined commodity, in comparison with a case that the predefined commodity is not included in the commodities associated with the user; and
the priority determination section makes the priority higher if the importance determined by the user importance determination section is higher.

11. The priority determination apparatus according to claim 1, further comprising:
a business hours acquisition section for acquiring business hours associated with each user; and
a user importance determination section for determining a higher importance if the present time is included in the business hours associated with the user identified by the user identification section, in comparison with a case that the present time is not included in the business hours, wherein the priority determination section makes the priority higher if the importance determined by the user importance determination section is higher.

12. The priority determination apparatus according to claim 11, further comprising a location area recording section for recording, in association with each user, a location area of that user:
wherein the business hours acquisition section acquires, for each user, a location area of that user from the location area recording section and acquires business hours predetermined in association with the location area.

13. The priority determination apparatus according to claim 1:
wherein the service request history recording section records the number of service requests made by a user, a response time from requesting a service by a user to returning a processing result, the volume of communication conducted by the application server through a network in response to a service request made by a user, or the number of transactions instructed by the application server to a database in response to a service request made by a user, as the service request history in association with the user;
the priority determination apparatus further comprises:
a total data value calculation section for calculating a total value by totalizing a sum of a value obtained by multiplying each data value of the service request history by a positive weight and a value obtained by multiplying each data value of the service request history by a negative weight, for all the data values; and
a user importance determination section for determining importance of each user based on the total value calculated by the total data value calculation section for that user,
wherein the priority determination section makes the priority higher if the importance determined by the user importance determination section is higher.

14. The priority determination apparatus according to claim 13, further comprising:
a priority policy recording section for recording, for each of at least one priority policy for giving priority to a service requested by a user, the weight set for each of the data values in a state where that priority policy is set in the priority determination apparatus, in association with a plurality of conditions to be satisfied in order to set that priority policy in the priority determination apparatus; and
a condition satisfaction judgment section for judging, for one of the priority policies, whether the plurality of conditions corresponding to the one priority policy is satisfied;
wherein the total data value calculation section calculates the total value by using a weight obtained by multiplying the weight corresponding to the one priority policy by a ratio of satisfied conditions among the plurality of conditions corresponding to the one priority policy.

15. A service processing allocation apparatus for allocating service processing requested by a user to an application server, comprising:
a service request history recording section for recording a service request history of services requested to the application server in association with each user who requested the services;
a user identification section for identifying a user who requested a service in response to receiving a request for the service made to the application server;
a priority determination section for determining a priority to be used in processing the service requested by the user on the basis of the service request history associated with the user, regarding the user identified by the user identification section;
a plurality of request queues for storing service requests made to the application server;
an enqueue processing section for enqueuing the service request made by the user into a request queue corresponding to the priority determined by the priority determination section; and
a request allocation section for acquiring a request from each of the plurality of request queues on the basis of the priority corresponding to that request queue and allocating the request to the application server.

16. The service processing allocation apparatus according to claim 15, further comprising:
a service type identification section for identifying a type of a service in response to receiving a request for the service made to the application server;
a user importance determination section for determining importance of each user on the basis of the service request history associated with the user;
request queues with the number less than a number obtained by multiplying the number of service importance levels by the number of user importance levels; and
a plurality of subqueues for storing requests obtained from any of the plurality of request queues,
wherein the priority determination section selects a higher priority from among a plurality of priorities fewer than a number obtained by multiplying the number of service importance levels by the number of user importance levels if the service is of the same type and the user importance is higher, or if the user importance is of the same level and the service importance is higher, the enqueue processing section further enqueues each of a plurality of requests acquired from one of the request queues into one of the subqueues determined in accordance with the user importance or the service importance under the condition that the levels of the user importance or the service importance differ from each other, and the request allocation section further acquires a request from each of the plurality of subqueues on the basis of the priority predetermined for that subqueue and allocates it to the application server.

17. A method of controlling a priority determination apparatus for determining a priority of a service to be processed by an application server, comprising:
a service request history recording step of recording a service request history of services requested to the application server in association with each user who requested the services;
a user identification step of identifying a user who requested a service in response to receiving a request for the service made to the application server; and
a priority determination step of determining a priority to be used in processing the service requested by the user on the basis of the service request history associated with the user, regarding the user identified by the user identification section.

18. A method of controlling a service processing allocation apparatus for allocating service processing requested by a user to an application server, wherein the service processing allocation apparatus includes a plurality of request queues for storing service requests made to the application server, the method comprising:
a service request history recording step of recording a service request history of services requested to the application server in association with each user who requested the services;
a user identification step of identifying a user who requested a service in response to receiving a request for the service made to the application server;
a priority determination step of determining a priority to be used in processing the service requested by the user on the basis of the service request history associated with the user, regarding the user identified by the user identification section; and
an enqueue processing step of enqueuing the service request made by the user into a request queue corresponding to the priority determined by the priority determination section; and
a request allocation step of acquiring a request from each of the plurality of request queues on the basis of the priority corresponding to that request queue and allocating the request to the application server.

19. A program for controlling a priority determination apparatus for determining a priority of a service to be processed by an application server, the program causing an information processing apparatus to function as:
a service request history recording section for recording a service request history of services requested to the application server in association with each user who requested the services;
a user identification section for identifying a user who requested a service in response to receiving a request for the service made to the application server; and
a priority determination section for determining a priority to be used in processing the service requested by the user on the basis of the service request history associated with the user, regarding the user identified by the user identification section.

20. A program for controlling a service processing allocation apparatus for allocating service processing requested by a user to an application server, the program causing an information processing apparatus to function as:
a service request history recording section for recording a service request history of services requested to the application server in association with each user who requested the services;
a user identification section for identifying a user who requested a service in response to receiving a request for the service made to the application server;
a priority determination section for determining a priority to be used in processing the service requested by the user on the basis of the service request history associated with the user, regarding the user identified by the user identification section;
a plurality of request queues for storing service requests made to the application server;
an enqueue processing section for enqueuing the service request made by the user into a request queue corresponding to the priority determined by the priority determination section; and
a request allocation section for acquiring a request from each of the plurality of request queues on the basis of the priority corresponding to that request queue and allocating the request to the application server.
